(19) United States
(12) Patent Application Publication
(10) Pub. No.: US 2015/0074648 A1
(43) Pub. Date: Mar. 12, 2015

(54) SOFTWARE DEFECT VERIFICATION

(71) Applicants: Dekel Tal, Gedera (IL); Ilan Meirman, Petah-Tikwa (IL)

(72) Inventors: Dekel Tal, Gedera (IL); Ilan Meirman, Petah-Tikwa (IL)

(21) Appl. No.: 14/391,689

(22) PCT Filed: Apr. 23, 2012
(86) PCT No.: PCT/US12/34676

§ 371 Date: Oct. 9, 2014

(51) Int. Cl. G06F 11/36

(52) U.S. Cl. CPC G06F 11/3688; G06F 11/3684
USPC 717/124

(57) ABSTRACT

Software defect verification is disclosed. An example method includes accessing, with a processor, a script representative of a set of actions to be performed when executing a software application to be tested, the set of actions being associated with a reported defect, executing the software application to be tested on the computer, and performing, with the processor, the set of actions in the script via the application to be tested to attempt to reproduce the reported defect.

### BACKGROUND

Software testing is a common part of software application development. Software testing includes interacting with the software in a way that an end user might be expected to interact with the software. When defects (or bugs) in the software are discovered, the underlying computer code defining the software is modified to correct the defects.

### BRIEF DESCRIPTION OF THE DRAWINGS

FIG. 1 is a block diagram of an example software development system constructed in accordance with the teachings of this disclosure.

FIG. 2 is a block diagram of an example software tester that may be used to implement the software tester of FIG. 1.

FIG. 3 is a block diagram of another example software tester that may be used to implement the software tester of FIG. 1.

FIGS. 4A-4E illustrate an example user interface of a software development system while monitoring user interactions during testing of a software application in accordance with the teachings of this disclosure.

FIGS. 5A-5D illustrate an example user interface of a software development system while verifying that a reported defect has been fixed in accordance with the teachings of this disclosure.

FIG. 6 is a flowchart representative of example machine readable instructions which, when executed, cause a processor to report a defect in a software application under test.

FIG. 7 is a flowchart representative of example machine readable instructions which, when executed, cause a processor to attempt to reproduce a reported defect in a software application under test.

FIG. 8 is a flowchart representative of example machine readable instructions which, when executed, cause a processor to attempt to reproduce a reported defect in a software application under test and verify whether the reported defect remains in the software application.

FIG. 9 is a block diagram of an example processor platform capable of executing the instructions of FIGS. 6-8 to implement the software testers of FIGS. 1, 2, and/or 3.

### DETAILED DESCRIPTION

In modern software development, a software application developer (also referred to herein as simply, a developer) generates code to implement a software application. As is common in software development, the software often initially contains defects (or bugs) that cause the behavior of the software to deviate from the desired or intended behavior. After the developer has written all or part of the software code, the software code may be sent to a software tester (e.g., a quality assurance engineer) for testing. For example, the software tester may test the software in various ways to verify that the software complies with the intended behavior.

When the software tester identifies instances of software behavior that do not comply with the intended behavior, the software tester reports the defect to the developer (e.g., directly and/or indirectly via a defect system). Reported defects may range from minor (e.g., cosmetic) to serious (e.g., core functionality issues). The developer then removes, modifies, and/or adds computer code to the software application to fix the reported defects. When the developer fixes the reported defects, the developer submits a new version of the software to the software tester. The software tester then verifies that the reported defect has been fixed. For example, the software tester may attempt to reproduce the condition that previously resulted in discovery of the defect and determine whether the defect may still be observed.

In the past, software defect verification has been a manual process. A person responsible for software testing (e.g., a quality assurance engineer) is notified when a reported defect has been addressed by the developer (or the quality assurance engineer may be the developer himself). The person must then attempt to reproduce the software defect by manually retesting the software application and determining whether the software defect still exists. Manual testing can therefore be an expensive and time-consuming process. The expense and time required to do manual testing may result in compromises to the software's quality (e.g., some defects may not be resolved in order to stay within budget, etc.).

Example methods, apparatus, and articles of manufacture may be used to perform software defect verification in a software development system. Example methods, apparatus, and articles of manufacture disclosed herein overcome the problems associated with the prior art by automating the process of verifying reported software defects. In some examples, an automated software tester records actions of a user conducting manual testing of a software application including interactions with the software application under test. When the user reports a defect in the software application, the software tester generates a script representative of the user actions resulting in the identification of the defect. The software tester attaches or appends the script to the reported defect. When the reported defect is later verified by the user (or a different user), the software tester executes the script to attempt to reproduce the defect. The developer may also use the script to reliably and rapidly reproduce the defect, which enables more efficient resolutions to reported defects.

In contrast to known software testing applications that create testing scripts in the abstract (i.e., with no association to a software defect), example methods, apparatus, and articles of manufacture disclosed herein are defect-centric. Example methods, apparatus, and articles of manufacture attach or associate a defect reproduction script to a reported defect, and attempt to reproduce a defect in response to selection of the defect by a user. In this manner, the example methods, apparatus, and articles of manufacture provide rapid verification of defects and enhanced software development efficiency.

Example computer-readable instructions are disclosed herein which cause a processor to identify a selection of a reported defect in a software application to be tested. Based on the selection, the instructions cause the processor to access a script representative of a set of actions to be performed by the computer when executing the software application to be tested. The set of actions is associated with the selected reported defect. The example instructions further cause the processor to execute the software application to be tested on the computer, and to perform the set of actions in the script to attempt to reproduce the reported defect.

An example apparatus disclosed herein includes a user interface, an application tester, and a defect reproducer. The example user interface is to receive a selection of a reported software defect for a software application to be tested. The application tester is to execute the software application under test. The example defect reproducer is to attempt to reproduce the selected reported software defect by performing, while the application tester executes the software application under test, a set of actions defined in a script. The set of actions are associated with the selected reported software defect.

As used herein, the term “verifying a defect” or “verifying a reported defect” refers to determining and/or confirming that a defect has been fixed or resolved satisfactorily according to a criterion (e.g., to the satisfaction of the verifier).

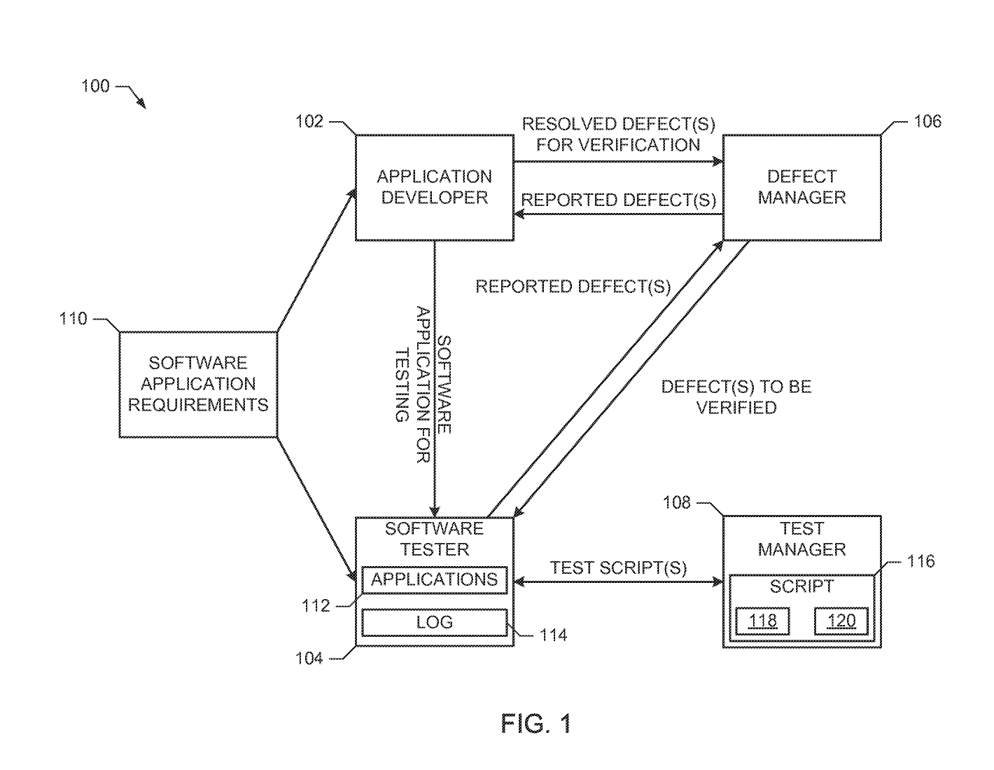

FIG. 1 is a block diagram of an example software development system 100. The example system 100 of FIG. 1 may be used to perform software defect verification for software applications in development and/or testing. The example of FIG. 1 includes an application developer 102, a software tester 104, a defect manager 106, and a test manager 108.

The example application developer 102 of FIG. 1 is used to develop or generate software applications. For example, the application developer 102 may be a development environment implemented on one or more computers, servers, networks, and/or other devices. One or more persons, such as software engineer(s), use the application developer 102 to write software code and/or generate executable software to be tested. The software application(s) may be developed to attempt to conform to received software application requirements 110. For example, the software application requirements 110 of FIG. 1 define the desired goals, objectives, inputs, outputs, visual requirements and/or behaviors of the software application. The application developer 102 provides the software application(s) for testing to the software tester 104.

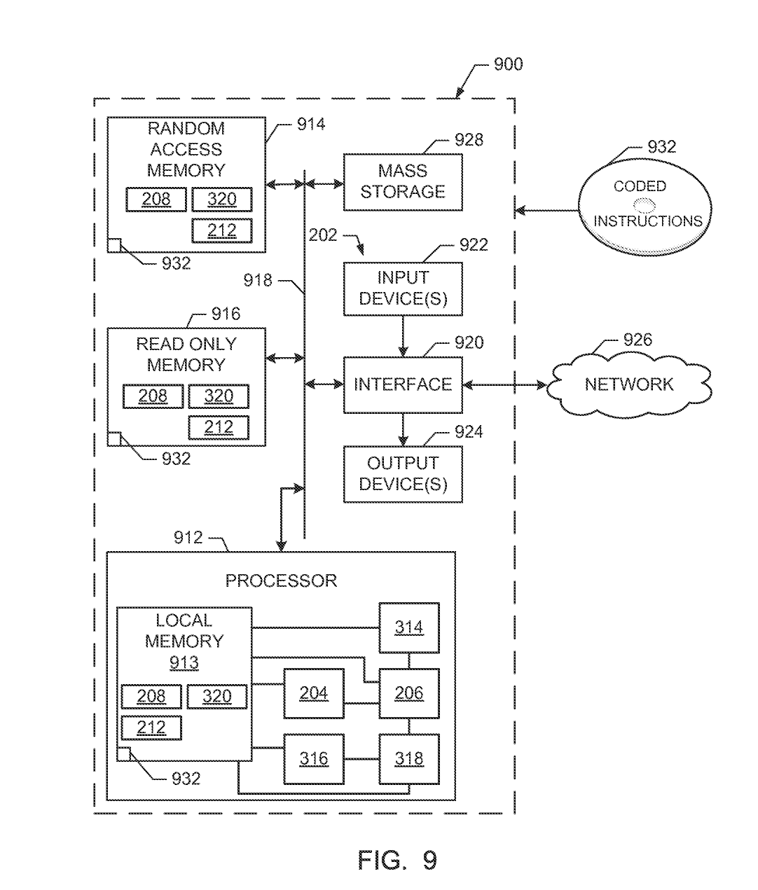

The example software tester 104 of FIG. 1 tests software applications to identify, report, and/or verify defects in the software applications (e.g., in different versions of a software application) provided by the application developer 102. In some examples, the software tester 104 is a testing tool executed on a computer or processing platform (e.g., the processing platform 900 of FIG. 9).

A user (e.g., a quality assurance engineer) may use the example software tester 104 of FIG. 1 to perform testing on software application(s) 112 provided by the application developer 102. While a user is testing the software applications 112 via the software tester 104, the software tester 104 automatically records interactions (e.g., data entered via a keyboard, objects selected using a cursor and/or a mouse, etc.) between the user and the software application. The software tester 104 of FIG. 1 stores representations of the recorded interactions in a user interaction log 114.

When the user identifies a defect in the software application under test 112, the user reports the defect via the software tester 104. For example, the user may generate a defect record via the software tester 104. The reported defect may include, for example, a defect identifier (e.g., a defect number), an expected behavior, an observed behavior, a suspected cause, a state or context in which the defect was observed, and/or any other information the user may believe to be helpful to the developer in resolving or fixing the reported defect.

In response to the user reporting the defect, the example software tester 104 generates a script including the interactions by the user that resulted in the software defect (e.g., the interactions recorded in the log 114). In some examples, the software tester 104 appends or attaches the script to the reported defect. Additionally or alternatively, the software tester 104 stores the script in the example test manager 108 (e.g., as an automated test). In some examples, the user may manually modify the script prior to appending the script to the reported defect to more precisely define the interactions leading to the reported defect.

The example defect manager 106 of FIG. 1 receives reported defects from the software tester 104 and provides reported defects to the application developer 102. In some examples, the application developer 102 retrieves the reported defects from the defect manager 106 (e.g., during a defect review). When the application developer 102 resolves (e.g., fixes) a reported defect received from the defect manager 106, the application developer returns or updates the reported defect in the defect manager 106. The example defect manager 106 provides resolved (but unverified) defects to the software tester 104 to be verified. For example, the software tester 104 may access the defect manager 104 during a reported defect verification period.

The example test manager 108 receives test script(s) 116 from the software tester 104. An example test script 116 includes defect reproduction instructions 118 to perform a set of steps that would produce evidence of one or more specific defects if those defects existed in the software application. In some examples, the test script further includes verification instructions 120 to identify the evidence of the one or more specific defects if those defects existed. When the software tester 104 is to verify that a reported defect has been fixed, the example software tester 104 accesses the appropriate test script 116 from the test manager 108. In some other examples, the example software tester 104 accesses the script 116 appended to the reported defect (e.g., in a defect record).

The example test manager 108 may also maintain a set of scripts 116 to perform automated testing of future versions of the software application 116. For example, the test manager 108 may provide tests for automated regression testing of the future versions to identify any defects that may have reappeared. The example software tester 104 provides scripts 116 associated with verified defects to the test manager 108, which includes the scripts 116 in future automated tests.

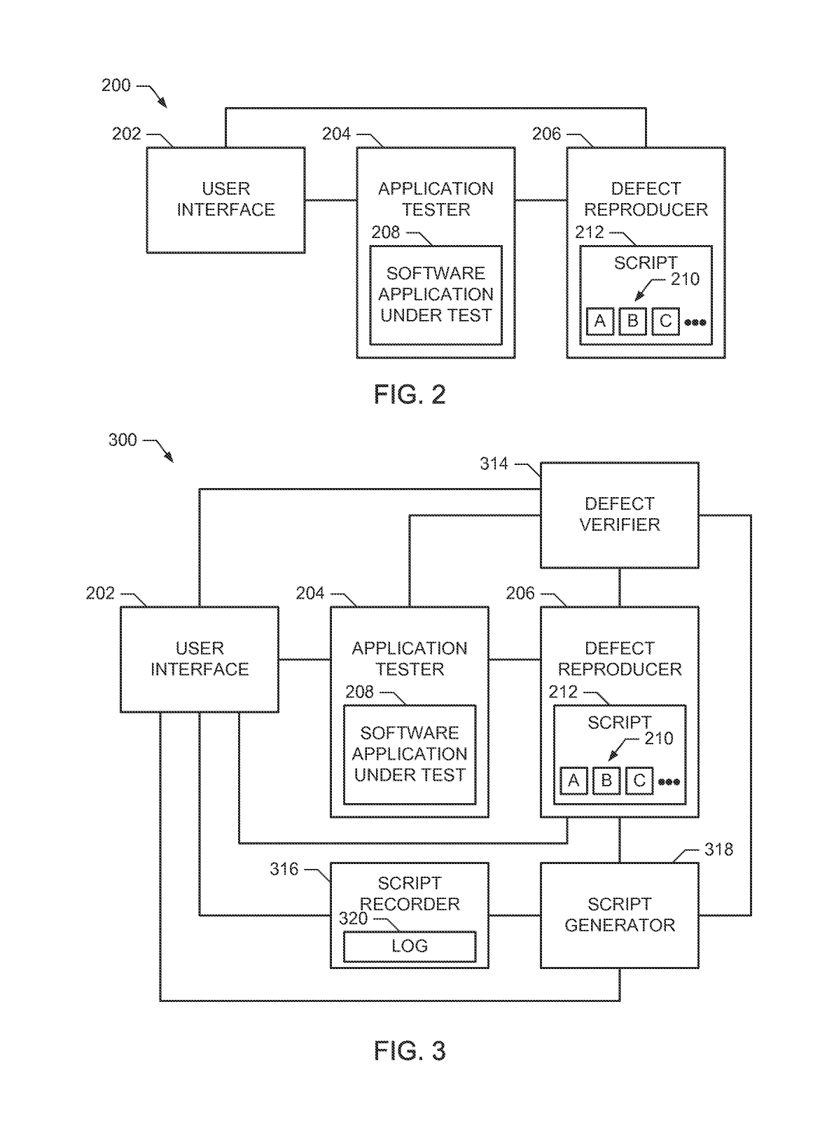

FIG. 2 is a block diagram of an example software tester 200 that may be used to implement the software tester 104 of FIG. 1. The example tester 200 of FIG. 2 includes a user interface 202, an application tester 204, and a defect reproducer 206. The software tester 200 may be implemented on, for example, the processing platform 900 described below with reference to FIG. 9.

The example user interface 202 of FIG. 2 receives inputs from and/or provides outputs to a user of the software tester 200. For example, the user interface 202 may include one or more of a display screen to show a visual display to the user, a keyboard to receive data inputs (e.g., keystrokes, alphanumeric character information, etc.), and/or a mouse to control a cursor and/or receive commands. During software testing and/or defect verification, the example user interface 202 receives a selection of a reported software defect for a software application to be tested (e.g., via a combination of inputs).

The example application tester 204 executes a software application 208 under test and monitors the executing software application. For example, the application tester 204 may receive an application to be tested (e.g., from the application developer 102 of FIG. 1). The example application tester 204 executes the software application under test 208 while monitoring the inputs and outputs of the executing application (e.g., network connections, user inputs, outputs to a user, peripheral inputs and/or outputs, service object calls into and/or out of the application, etc.).

A user may interact with the application tester 204 and/or the software application to be tested 208 via the user interface 202. For example, the user interface 202 enables the user to select menu items or actions provided by the application tester 204 (e.g., selecting a defect, verifying a defect, reporting a defect, executing the application 204, etc.). The user interface 202 also enables the user to interact with the software application and its features (via the application tester 204).

The example defect reproducer 206 of FIG. 2 attempts to reproduce the selected reported software defect (e.g., determined via the user interface 202). To this end, the example defect reproducer 206 automatically (e.g., without user involvement) performs a set of actions 210 defined in a script 212 (e.g., the script 116 of FIG. 1) while the application tester 204 executes the software application under test 208. The set of actions 210 of FIG. 2 include instructions to reproduce the selected reported software defect (e.g., if the defect was not fixed). In some examples, the set of actions 210 was automatically recorded during prior testing of the software application 208 (or an earlier version of the software application under test 208) and appended to the reported defect via the script 210.

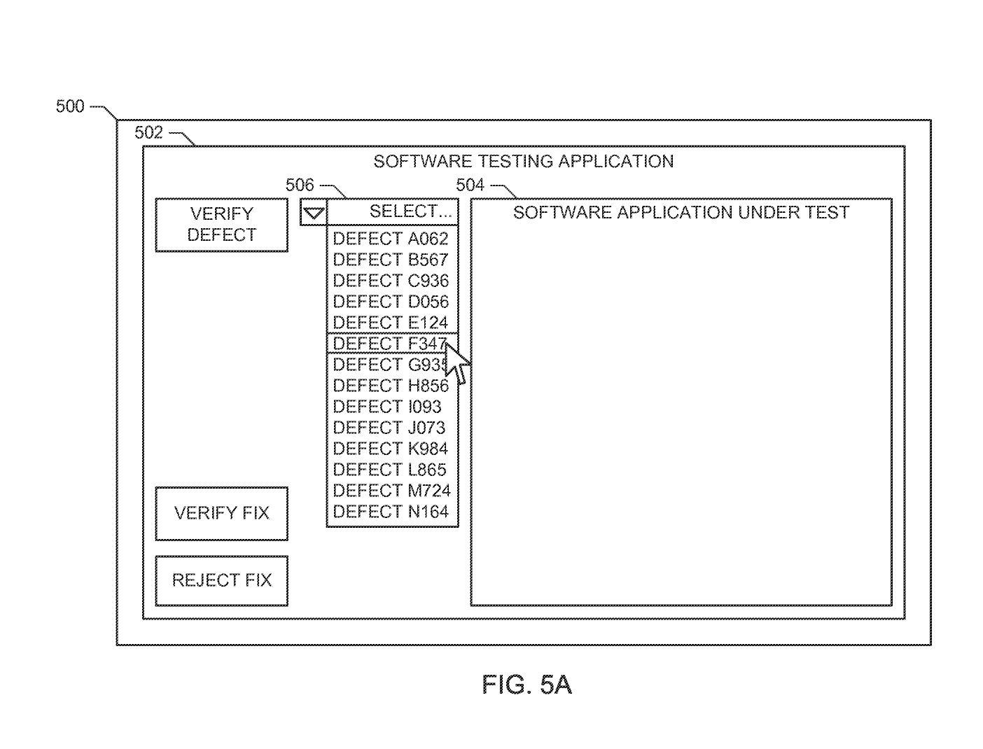

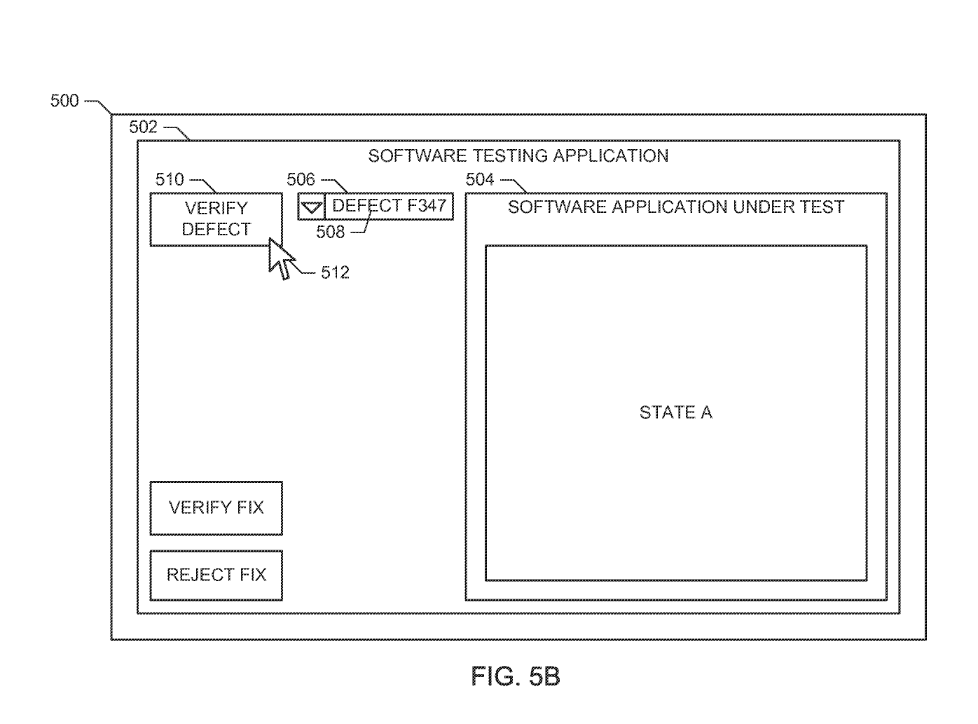

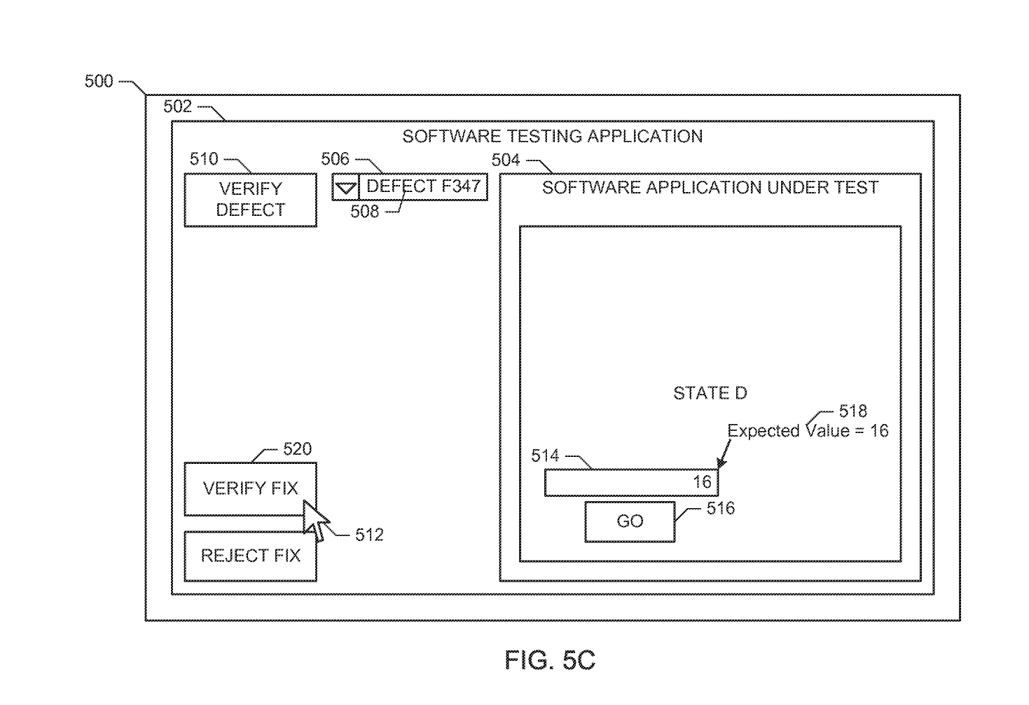

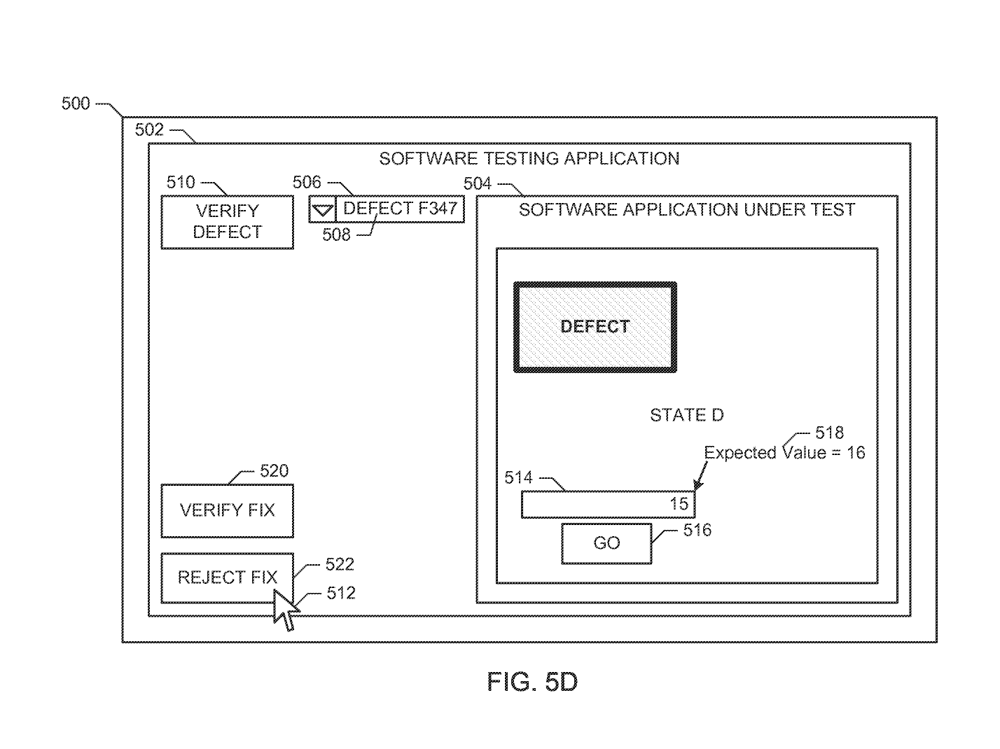

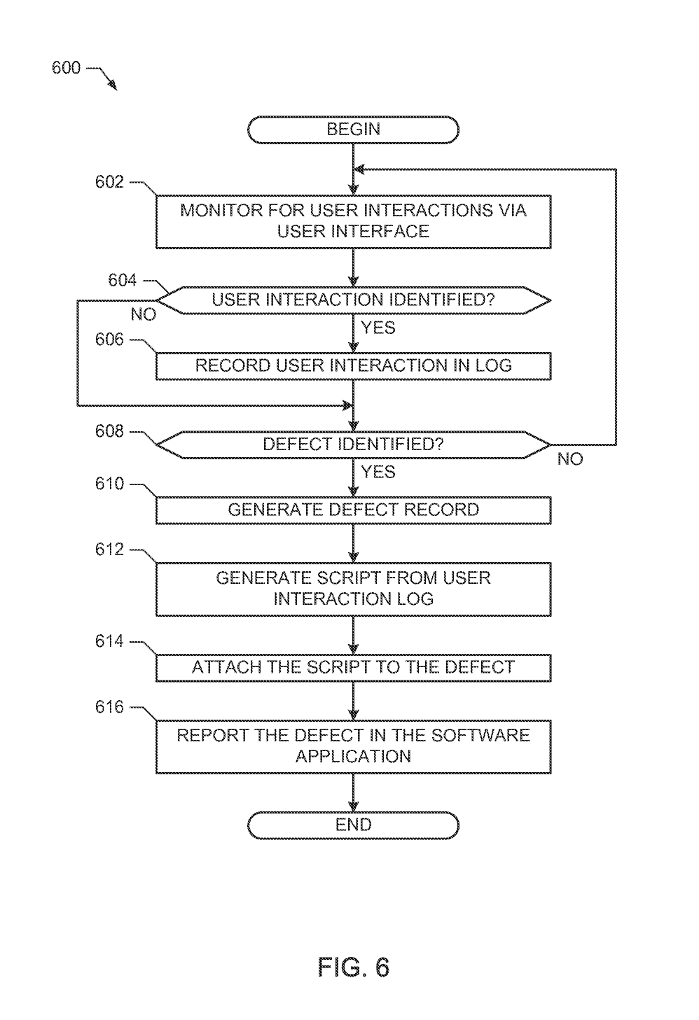

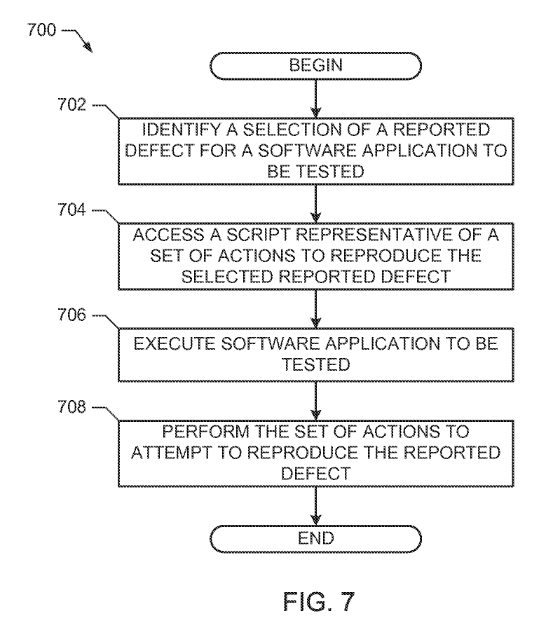

More detailed operation of the example software tester 200 is described below with reference to FIGS. 5A-5D, FIG. 6, and/or FIG. 7.

FIG. 3 is a block diagram of another example software tester 300 that may be used to implement the software tester 104 of FIG. 1. The example of FIG. 3 includes the example user interface 202, the example application tester 204, and the example defect reproducer 206 of FIG. 2. However, in contrast with the software tester 200 of FIG. 2, the example software tester 300 of FIG. 3 further includes a defect verifier 314, a script recorder 316, and a script generator 318. The software tester 300 may be implemented on, for example, the processing platform 900 described below with reference to FIG. 9.

The example defect verifier 314 of FIG. 3 determines whether the selected reported software defect has been removed from the software application 208 when the set of actions 210 have been performed. For example, the defect verifier 314 may request and/or receive information from the user interface 202 and/or the application tester 204 that evidences the presence or absence of the selected reported software defect. In some examples, the script 212 includes one or more instructions to obtain and/or evaluate whether the reported defect has been fixed. The defect verifier 314 uses these instructions to verify the reported defect.

The type of information and/or evidence obtained and/or used by the defect verifier 314 may be different depending on the specific reported defect. For example, a reported defect with the user interface of the software application under test 208 (e.g., an incorrect graphic) may be verified by obtaining output information from the user interface 202. In contrast, a reported defect pertaining to a data processing error may be verified by obtaining data inputs and/or outputs of the software application under test 208 from the application tester 204.

The example script recorder 316 of FIG. 3 monitors user interactions with the software application under test 208. For example, the script recorder 316 receives inputs from the user interface 202. These inputs may include a type of input (e.g., a mouse click, a cursor movement, a cursor location, a keystroke), a data structure associated with (e.g., affected by) the input (e.g., a data field into which the user is typing characters, a clickable button, etc.), entered data (e.g., alphanumeric characters, etc.), and/or any other information characterizing the user interaction. The example script recorder 316 stores the monitored interactions in a user interaction log 320. In some examples, the script recorder 316 automatically (i.e., without user interaction) records timestamps, outputs to the user interface 202, inputs and/or outputs to the software application 208 (e.g., via the application tester 204), and/or any other information that may be useful or necessary to reproduce the defect in the software application.

Based on interactions recorded in the log 320, the example script generator 318 generates a script (e.g., the script 212) from the monitored user interactions. In the example of FIG. 3, the script generator 318 generates the script when the user interface 202 receives an indication that a software defect is to be reported. Such an indication may include the user clicking on a “report defect” button (e.g., when the user identifies a defect in the software application under test 208). The example script generator 318 may provide the generated script (e.g., the script 212) to the defect reproducer 206 and/or to the defect verifier 314. In some examples, the script generator 318 appends the generated script 212 to a report of a defect.

Example tools that may be used to implement the application tester 204, the script recorder 316, and/or the script generator 318 of FIGS. 2 and/or 3 are the QuickTest Professional™ software suite, developed by Hewlett-Packard, and/or the HP Functional Testing™ software, also developed by Hewlett-Packard.

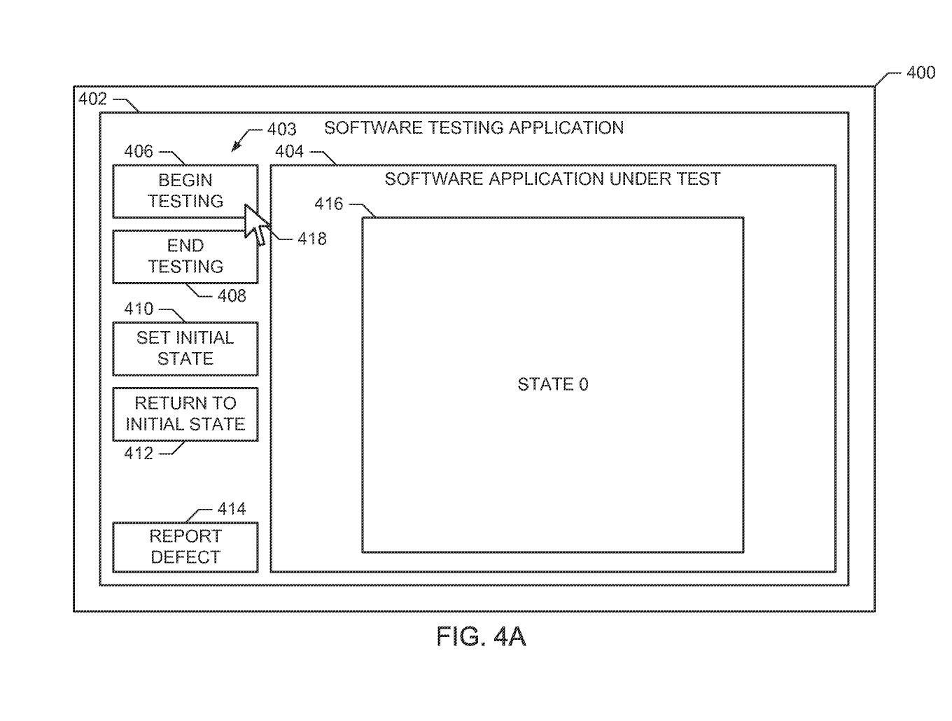

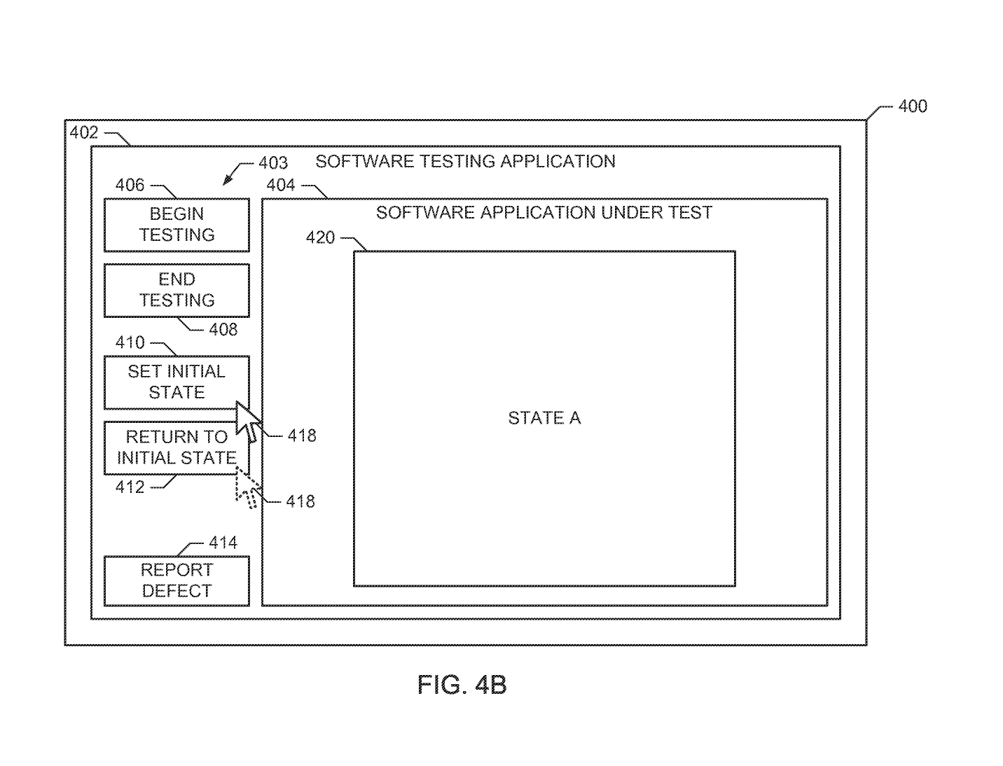

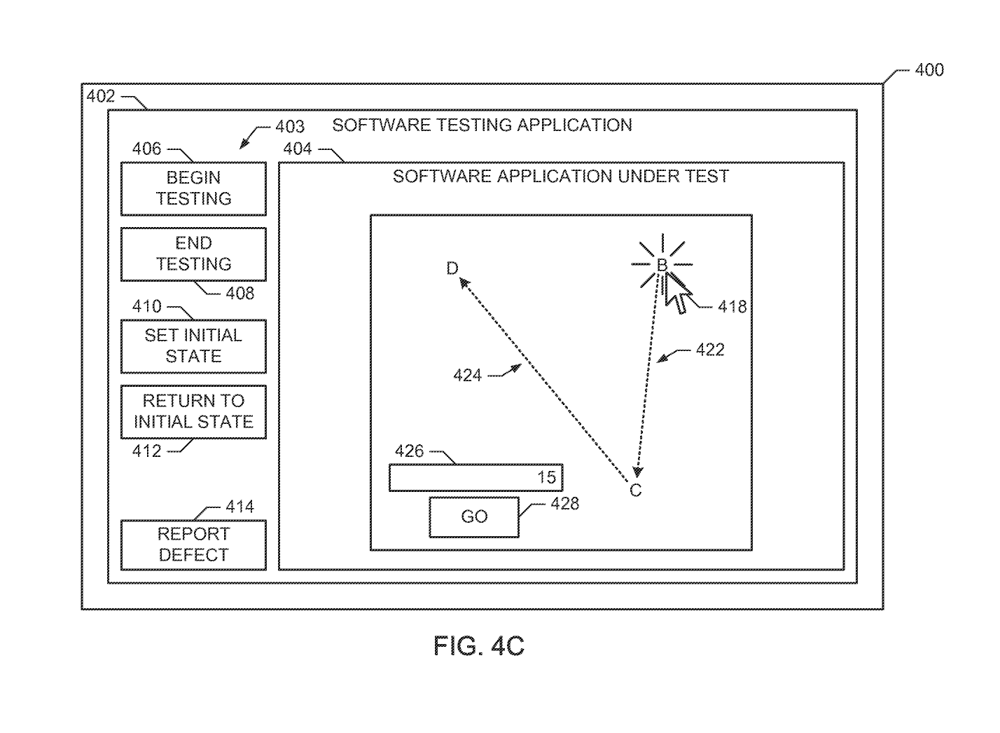

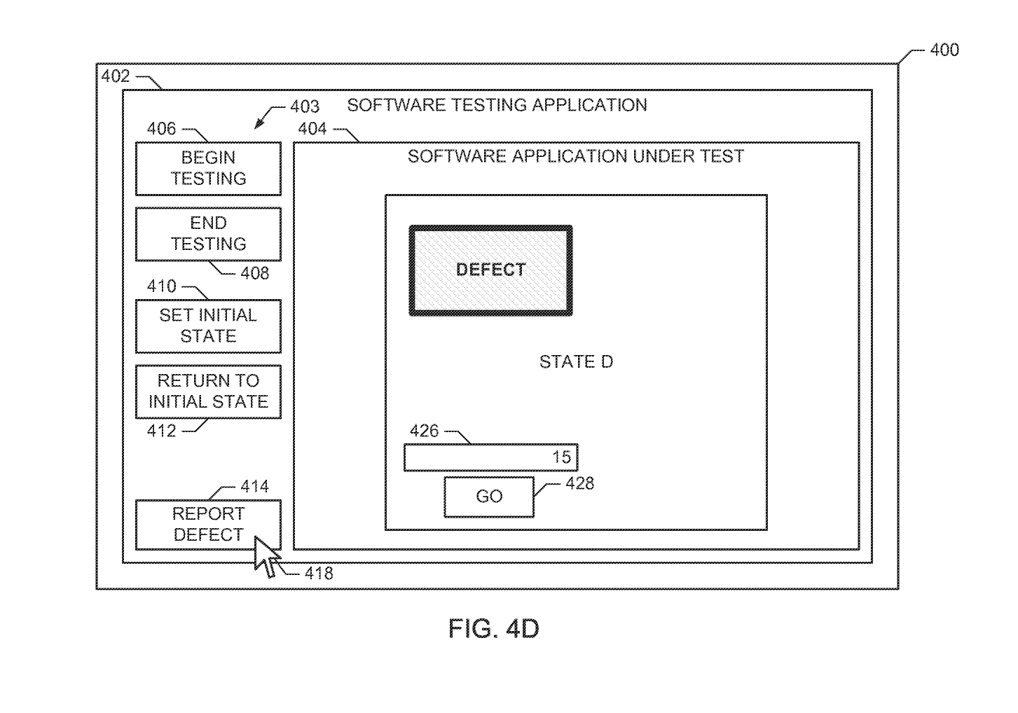

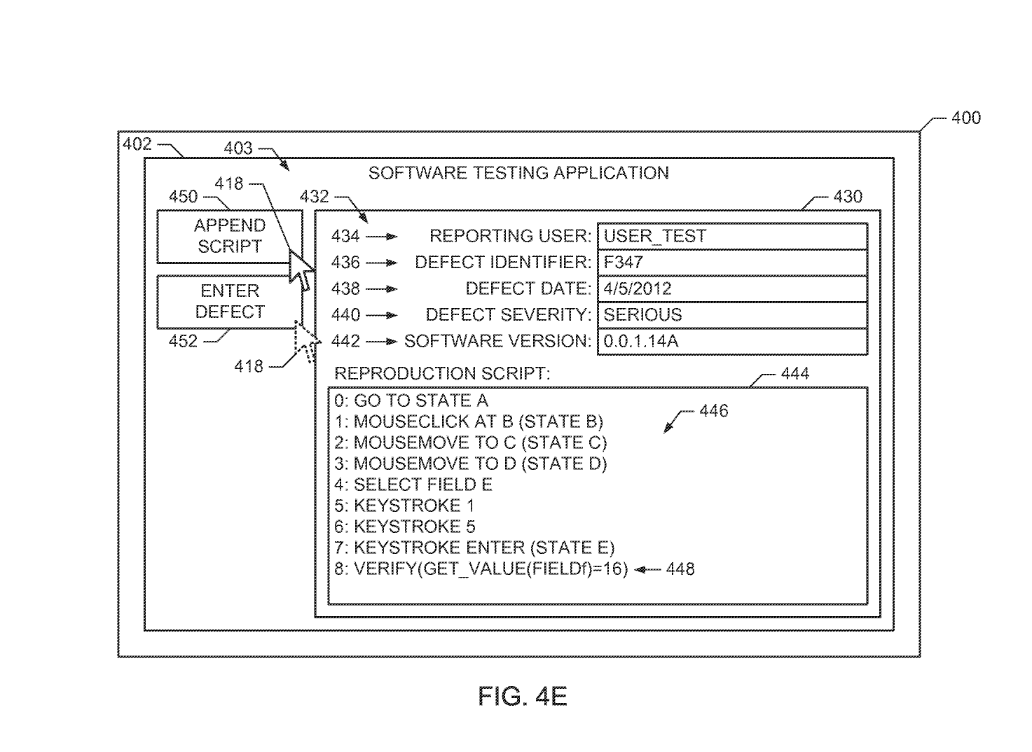

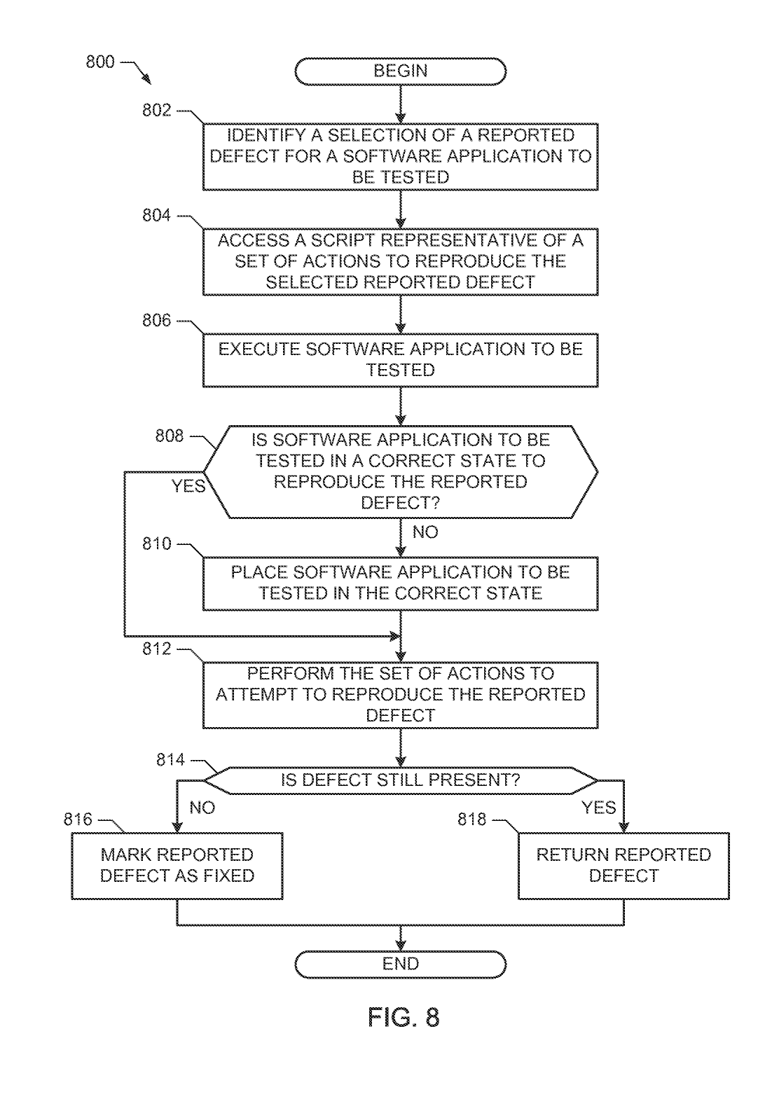

More detailed operation of the example software tester 300 of FIG. 3 is described below with reference to FIGS. 4A-4E, FIGS. 5A-5D, FIG. 6, FIG. 7, and/or FIG. 8.

FIGS. 4A-4D illustrate an example user interface 400 of a software development system (e.g., the software development system 100 of FIG. 1) while the software development system 100 monitors user interactions during testing of a software application. The example user interface 400 of FIGS. 4A-4D may be presented to a user on a display screen.

The user interface 400 of the illustrated example includes a window corresponding to (e.g., generated by) a software testing application 402 (e.g., by the application testers 204 of FIGS. 2 and/or 3). In the example of FIGS. 4A-4D, the software testing application 402 is being used to test a software application (e.g., the software application under test 208 of FIG. 2) which is generating an output implemented by a display pane or window 404. The software testing application 402 of the illustrated example provides a control interface 403 with which a user can initiate a test of the software application (e.g., via a begin testing button 406) and/or end a test of the software application (e.g., via an end testing button 408).

In the example of FIGS. 4A-4D, the example software testing application further enables a user to set a state of the software application under test as an initial state (e.g., via a set initial state button 410) and/or return the software application to an initial state (e.g., via a return to initial state button 412). As used herein, the term “initial state” refers to a starting point from which testing is to begin, corresponding to any state of a software application under test (e.g., simulated system conditions, such as memory contents), from which a set of instructions or steps can be performed to attempt to reproduce a software defect. For example, any particular state of a software application under test may be designated as the initial state. A user (e.g., a tester) of the software application may then return to the initial state at any time during, after, and/or to start a test. Thus, a set of steps in a script may use the initial state (e.g., the designated starting point) to reliably reproduce software defects if they have not been fixed and/or to verify that the defects have been fixed, because the steps to reproduce the software defect are initiated from the same system and/or software conditions as the steps initially taken to discover the defect.

An initial state of the software application under test may be specified by, for example, the contents of memory allocated to the application, the state(s) of enabled add-on application(s), a programmed steady state (e.g., home screen, menu screen, etc.) of the software application, and/or any other method of specifying a state of a software application. In some examples, the state of the software application under test 404 is compatible with a state of a subsequent version of the software application.

The example software testing application of FIGS. 4A-4D further enables a user to report a software defect (e.g., via a report defect button 414). When the user of the software testing application identifies or observes a defect, the user may select (e.g., click) the report defect button 414 to cause the software testing application to report a defect in the software application under test. As described in more detail below, reporting a software defect may include generating a defect record that specifies information about the defect.

FIG. 4A illustrates the example user interface 400 while the software testing application is testing the software application under test. In the example of FIG. 4A, the software application under test is in a first state 416 (e.g., state 0). The example first state 416 may be a first state into which the software application under test enters when a user selects (e.g., clicks via a cursor 418) the begin testing button 406. Upon selection of the begin testing button 406, actions of the user and/or the software application under test are monitored (e.g., via the user interface 202, the application tester 204, and/or the script recorder 316 of FIGS. 2 and/or 3).

FIG. 4B illustrates the user interface 400 of FIG. 4A while example user interactions with the software application under test are being monitored. In the example of FIG. 4B, the software application under test has entered another state 420 (e.g., state A).

In some examples, the user may cause the software application under test to enter the state 420 by interacting with the software application under test via the user interface 400 and/or the software testing application. When the software application under test enters the state 420, the user may set (or assign) the state 420 as an initial state (e.g., by selecting the set initial state button 410 with the cursor).

In some other examples, the user may cause the software application under test to return to the initial state (e.g., state 420) by selecting the return to initial state button 412 via the cursor 418. When the software application under test is in the initial state 420, the example script recorder 316 of FIG. 3 records that the software application under test is in the initial state. This information may later be used to provide a script with a state (e.g., the initial state 420) from which a set of actions is to be performed.

FIG. 4C illustrates the user interface 400 of FIG. 4A while example user interactions subsequent to an initial state are being monitored. In the example of FIG. 4C, the user conducts testing of the software application under test by clicking (e.g., via a mouse) the cursor 418 at a location within the display pane 404 output by the software application under test (e.g., in an application window) at a location B. The example log recorder 316 of FIG. 3 records a user interaction received via the example user interface 400 (e.g., the user interface 202 of FIG. 3).

The example test continues with the user moving 422 the cursor 418 to a second location C within the display pane 404 output by the software application under test and by moving 424 the cursor 418 to another location D within the display pane 404 output by the software application under test. The example log recorder 316 may record these user interactions received via the user interface 400 as separate actions and/or as a single action (e.g., based on whether the movement 422 modified a state of the software application under test.

The user then selects (e.g., via a mouse click, a ‘tab’ keystroke, etc.) a data entry field (e.g., a text box 426) within the display pane 404 output by the software application under test and enters a number (e.g., ‘15’) by making two keystrokes (e.g., a ‘1’ keystroke followed by a ‘5’ keystroke). The example log recorder 316 records these user interactions via the user interface 400. As with the movement interactions 422, 424, the example log recorder 316 may record these user interactions as individual actions and/or as a single action.

For example, if either the ‘1’ keystroke or the ‘5’ keystroke (or both) results in a change of software state (e.g., a change of allocated memory contents), the keystroke(s) may be considered a separate action.

A data entry button (e.g., ‘GO’) 428 is then selected (e.g., by clicking with a mouse, by striking an ‘ENTER’ key on the keyboard, etc.). According to the intended behavior of the software, after the user selects the ‘GO’ button 428, the software application under test should be in a state E. The example log recorder 316 records the selection of the button 428 to be consistent with the method (e.g., mouse click, keystroke, etc.) with which the user selected the button 428. However, the example log recorder 316 may also record equivalents to the action (e.g., record pressing an ‘ENTER’ key in addition to moving the cursor 418 over the button and clicking a mouse).

FIG. 4D illustrates the user interface 400 of FIG. 4A when an example software defect is to be reported by a user. According to the expected behavior of the example software application under test, the value displayed in the data entry field 426 is to be changed to another number (e.g., ‘16’). However, in the illustrated example, the value of the field 426 remains as the entered number ‘15.’ Furthermore, the software application under test remains in state D instead of transitioning to state E as expected according to example software requirements (e.g., the software application requirements 110 of FIG. 1). As a result, the user identifies that a software defect exists and selects the report defect button 414 via the cursor 418.

FIG. 4E illustrates the user interface 400 of FIG. 4A while the software testing application presents a dialog 430 for a user to report a defect in the software application under test. The example software testing application presents the dialog 430 in response to the user selecting the report defect button 414 of FIGS. 4A-4D.

In the example of FIG. 4E, the dialog 430 presents a defect record 432 (e.g., generated by the application tester 204 of FIGS. 2 and/or 3). The defect record 432 includes information including an identification of a reporting user 434, a defect identifier 436, a defect date (e.g., a timestamp) 438, a defect severity 440, an identification of the version 442 of the software application under test, and a defect reproduction script 444. In some examples, the user may append comments, a screenshot illustrating the defect, and/or other information to the defect record 432.

The example defect reproduction script 444 (e.g., the script 116 of FIG. 1, the scripts 212 of FIGS. 2 and/or 3) includes instructions 446 representative of a set of actions (e.g., the actions 210 of FIGS. 2 and/or 3) that may be performed to attempt to reproduce the defect being reported in the defect record 432. In the example of FIG. 4E, the defect reproduction script 444 is initially populated with the instructions 446 by a script generator (e.g., the script generator 318 of FIG. 3). The user may add to, delete, and/or modify the instructions 446. For example, the script 444 includes a verify instruction 448 added by a user. The example verify instruction 448 enables a defect verifier (e.g., the defect verifier 314 of FIG. 3) to verify that a defect has been fixed.

When the defect reproduction script 444 is satisfactorily complete, the user may select an append script button 450 (e.g., via the cursor 418) to cause the script generator 318 to append the script 444 to the record 432. In some other examples, the script 444 may be appended to the defect record 432 automatically and/or may be integral to the defect record 432. When the defect record 432 has been satisfactorily prepared by the user (e.g., to the user's satisfaction), the user may select an enter defect button 452.

While FIGS. 4A-4E illustrate an example of testing a software application, recording user interactions, and reporting a defect, the example may be modified to test any type(s) of software application and record any type(s) of interaction. The recorded interactions, the tests performed, and/or the defects reported are based on the software application requirements (e.g., the intended behavior) and the coding of the software application. Accordingly, an almost limitless number of variations of monitored interactions and reported defects are possible. The example software testers 300 of FIG. 3 may be used to report such defects and generate scripts representative of the interactions resulting in identifying or observing the defects.

FIGS. 5A-5D illustrate an example user interface 500 of a software development system (e.g., the software development system 100 of FIG. 1) while verifying that a reported defect has been fixed. The example user interface 500 of FIGS. 5A-5D may be the same or similar to the user interface 400 of FIG. 4 and/or may be used to implement the user interfaces 202 of FIGS. 2 and/or 3.

The example user interface 500 of FIGS. 5A-5D includes a display pane or window 502 generated by a software testing application (e.g., a display window on the user interface 500 with which the user can interact with the software testing application). The software testing application of FIGS. 5A-5D may implement any and/or all of the example software testers 104, 200, 300 of FIGS. 1-3. The example software testing application operating in the example of FIGS. 5A-5D may be the same or different as the software testing application of FIGS. 4A-4E.

Furthermore, the software testing application operating in the example of FIGS. 5A-5D may be executed on the same or a different processing platform as the software testing application of FIGS. 4A-4E. Accordingly, a reported defect may be verified on the same processing platform and/or software testing application as the defect was reported. Alternatively, the reported defect may be verified on a different processing platform and/or software testing application from which the defect was reported. Advantageously, the software testing application of FIGS. 5A-5D efficiently and rapidly verifies software defects using a script even if the defect was not reported via the software testing application.

The example software testing application of FIGS. 5A-5D is to verify a software application under test. In the example of FIGS. 5A-5D, the example software application under test is a subsequent version of the software application under test of FIGS. 4A-4E. For example, the software application under test has been modified (e.g., by a software developer) to attempt to resolve or fix a defect.

FIG. 5A illustrates the example user interface 500 while a user is selecting a reported defect to be verified. The example user interface 500 displays a display window 504 corresponding to the software application under test (e.g., generated by the software application under test). The display window 504 may be displayed side-by-side with the window 502 generated by the software test application and/or as a sub-window of the window 502.

In the illustrated example of FIG. 5A, the software testing application includes a selection tool, such as a dropdown box 506 populated with reported defects for the software application. The user may select the dropdown box 506 and then select a reported defect 508 (e.g., ‘Defect F347’) from the listed defects. The example selected reported effect F347 is the same reported defect as the example reported defect illustrated in FIG. 4E. Thus, the selected reported defect is associated with (e.g., includes, is appended with) a script to attempt to reproduce the reported effect.

FIG. 58 illustrates the example user interface 500 of FIG. 5A while the user is selecting to verify the selected reported defect. In the example of FIG. 5B, the user has selected a verify defect button 510. In response to receiving a selection of the verify defect button 510 for a selected reported defect 508, the example software testing application attempts to reproduce the reported defect by executing a script (e.g., a script included with and/or appended to a defect record for the reported defect, the script 116 of FIG. 1, the scripts 212 of FIGS. 2 and/or 3). The user may select the verify defect button 510 using, for example, a cursor 512.

In response to the user selecting to verify the reported defect 508, the example software testing application begins executing the script. In the illustrated example, the software testing application first places the software application under test into a first state A (e.g., the initial state 420 of FIG. 4B) based on the script.

FIG. 5C illustrates the example user interface 500 of FIG. 5A when the software testing application has executed a script appended to the selected reported defect. According to the example script, the software application under test should be in a state D, where the keystrokes ‘15’ have been entered into a field 514 and a ‘GO’ button 516 has been selected e.g., via the defect reproducer 206 and the user interface 202 of FIGS. 2 and/or 3). In the illustrated example, the software testing application also shows an annotation 518 highlighting of the location of the reported defect (e.g., where the defect may be observed) and/or the expected content.

In the example of FIG. 5C, the example software application under test has performed a calculation and populated the field 514 with the value ‘16.’ This value is consistent with an expected value shown in the highlight 518. As a result, the user may confirm or verify that the reported defect has been fixed by selecting a verify fix button 520.

FIG. 5D illustrates the example user interface 500 of FIG. 5A when the software testing application has executed a script appended to the selected reported defect and the reported defect remains. As shown in FIG. 5D, the value in the example field 514 does not match the value illustrated in the annotation 518. When the user identifies that the defect remains (e.g., by observing the difference between the annotation 518 and the field 514, the user may select a reject fix button 522 to reject the fix (e.g., reopen or return the reported defect to the software developer to be addressed).

While example manners of implementing the software tester 104 of FIG. 1 has been illustrated in FIGS. 2 and 3, one or more of the elements, processes and/or devices illustrated in FIGS. 2 and/or 3 may be combined, divided, re-arranged, omitted, eliminated and/or implemented in any other way. Further, the example user interface 202, the example application tester 204, the example defect reproducer 206, the example software application under test 208, the example set of actions 210, the example script 212, the example defect verifier 314, the example script recorder 316, the example script generator 318 and/or, more generally, the example software testers 104, 200, 300 of FIGS. 1-3 may be implemented by hardware, software, firmware and/or any combination of hardware, software and/or firmware. Thus, for example, any of the example user interface 202, the example application tester 204, the example defect reproducer 206, the example software application under test 208, the example set of actions 210, the example script 212, the example defect verifier 314, the example script recorder 316, the example script generator 318 and/or, more generally, the example software testers 104, 200, 300 of FIGS. 1-3 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example user interface 202, the example application tester 204, the example defect reproducer 206, the example software application under test 208, the example set of actions 210, the example script 212, the example defect verifier 314, the example script recorder 316, and/or the example script generator 318 are hereby expressly defined to include a tangible computer readable medium such as a memory, DVD, CO. Blu-ray, etc. storing the software and/or firmware. Further still, the example software testers 104, 200, 300 of FIGS. 1-3 may include one or more elements, processes and/or devices in addition to, or instead of, those illustrated in FIG. 4, and/or may include more than one of any or all of the illustrated elements, processes and devices.

Flowchart representative of example machine readable instructions for implementing any of the software testers 104, 200, 300 of FIGS. 1-3 are shown in FIGS. 6-8. In this example, the machine readable instructions comprise a program for execution by a processor such as the processor 912 shown in the example computer 900 discussed below in connection with FIG. 9. The program may be embodied in software stored on a tangible computer readable medium such as a computer readable storage medium (e.g., a CD-ROM, a floppy disk, a hard drive, a digital versatile disk (DVD), a Blu-ray disk, or a memory associated with the processor 912), but the entire program and/or parts thereof could alternatively be executed by a device other than the processor 912 and/or embodied in firmware or dedicated hardware. Further, although the example program is described with reference to the flowchart illustrated in FIGS. 6-8, many other methods of implementing the example software testers 104, 200, 300 may alternatively be used. For example, the order of execution of the blocks may be changed, and/or some of the blocks described may be changed, eliminated, or combined.

As mentioned above, the example processes of FIGS. 6-8 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example processes of FIGS. 6-8 may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

FIG. 6 is a flowchart representative of example machine readable instructions 600 which, when executed, cause a processor to report a defect in a software application under test. The example instructions 600 may be executed by the example processor platform 900 of FIG. 9 to implement the user interface 202, the application tester 204, the script recorder 316, and/or the script generator 318 of FIG. 3.

The example instructions 600 begin by monitoring (e.g., via the script recorder 316 of FIG. 3) for user interactions via a user interface (e.g., the user interface 302 of FIG. 3, the user interface 400 of FIG. 4) (block 602). For example, the script recorder 316 may monitor the user interface 202 to identify user inputs such as keystrokes, mouse movements, mouse clicks, audio input, imaging device input, and/or any other type of user interaction. If a user interaction has been identified (block 604), the example script recorder 316 records the user interaction in a user interaction log (e.g., the log 320) (block 606).

When the user interaction has been recorded (block 606), or if a user interaction has not been identified (block 604), the example application tester 204 determines whether a defect has been identified (e.g., whether the user has indicated that a defect has been observed via the user interface 202) (block 608). If a defect has not been identified (block 608), control returns to block 602 to continue monitoring for user interactions.

If a defect has been identified (block 608), the example application tester 204 generates a defect record (e.g., the defect record 432 of FIG. 4E) (block 610). The example defect record 432 may include an assigned defect identifier, an identifier of the user who generated the defect record, remarks from the user, a timestamp, a severity of the defect, a version of the software application under test (e.g., the software application under test 208 of FIGS. 2 and 3 and/or the software application under test of FIG. 4).

The example script generator 318 of FIG. 3 generates a script (e.g., the script 212 of FIG. 3, the defect reproduction script 444 of FIG. 4E) from the user interaction log 320 (block 612). The script 444 includes instructions for a defect reproducer (e.g., the defect reproducer 206 of FIGS. 2 and 3) representative of user interactions such as, for example, user interactions since the most recent occurrence of a designated initial state (e.g., state A 420 of FIG. 4B), user interactions since the beginning of a test (e.g., since the user selected the begin testing button 406 of FIGS. 4A-4E), a designated number of most recent interactions (e.g., the last 30 interactions), and/or any other number or representation of interactions.

The example script generator 318 attaches (e.g., appends) the script 444 to the defect (e.g., to the defect record 432) (block 614). For example, the script generator 318 may automatically include (e.g., append) the script 444 in the defect record. The example application tester 204 reports the defect in the software application under test (block 616). For example, the application tester 204 may provide the defect record 432 including the script 444 to a defect manager 106 and/or to an application developer 102.

After reporting the defect (block 616), the example instructions 600 of FIG. 6 may end. The example instructions 600 may then be restarted from the beginning when a user begins another test. In some other examples, the instructions 600 may return control to block 602 to continue monitoring for user interactions without additional user commands (e.g., without restarting the instructions 600).

FIG. 7 is a flowchart representative of example machine readable instructions 700 which, when executed, cause a processor to attempt to reproduce a reported defect in a software application under test. The example instructions 700 may be performed by the example processor platform 900 of FIG. 9 to implement the example software testers 104, 200, 300 of FIGS. 1, 2, and/or 3.

The instructions 700 of FIG. 7 begin by identifying (e.g., via the user interface 202 of FIGS. 2 and 3) a selection of a reported software defect for a software application to be tested (block 702). For example, the user interface 202 may receive one or more commands from a user indicating a selection of a reported software defect (e.g., the software defect 508 of FIGS. 5B-5D) for a software application under test (e.g., the software application under test of FIGS. 5A-5D).

A defect reproducer (e.g., the example defect reproducer 206 of FIGS. 2 and/or 3) accesses a script representative of a set of actions to reproduce the selected reported defect 508 (block 704). For example, the defect reproducer 206 may receive a script (e.g., the defect reproduction script 444 of FIG. 4E) that is included in a defect record (e.g., the defect record 432 of FIG. 4E). In some examples, the defect reproducer 206 accesses the defect record 432 and/or the script 444 from a defect manager (e.g., the defect manager 106 of FIG. 1).

An application tester (e.g., the example application tester 204 of FIGS. 2 and/or 3) executes the software application to be tested (e.g., the software application under test 504 of FIGS. 5A-5D) (block 706). The defect reproducer 206 performs the set of actions (e.g., actions in the script 444) to attempt to reproduce the reported defect (block 708). By performing the set of actions, the example defect reproducer 206 attempts to reproduce the condition via which a user (e.g., a quality assurance engineer) previously determined that the selected defect existed. If the defect has not been fixed, the user that selected the reported defect for verification may observe that the defect is still present without having to manually retrace the steps. On the other hand, if the defect has been fixed, the user may observe that the reported defect has been fixed without having to manually retrace the steps.

The example instructions 700 may then end. In some examples, the instructions 700 may return control to block 702 to identify a selection of another reported defect for verification. In this manner, a quality assurance engineer may rapidly verify that multiple reported defects have been fixed.

FIG. 8 is a flowchart representative of example machine readable instructions 800 which, when executed, cause a processor to attempt to reproduce a reported defect in a software application under test and verify whether the reported defect remains in the software application. The example instructions 700 may be performed by the example processor platform 900 of FIG. 9 to implement the example software testers 104, 300 of FIGS. 1 and/or 3.

The example instructions 800 of FIG. 8 begin by identifying (e.g., via the user interface 202 of FIG. 3) a selection of a reported software defect for a software application to be tested (block 802). For example, the user interface 202 may receive one or more commands from a user indicating a selection of a reported software defect (e.g., the software defect 508 of FIGS. 5B-5D) for a software application under test (e.g., the software application under test 504 of FIGS. 5A-5D).

A defect reproducer (e.g., the example defect reproducer 206 of FIG. 3) accesses a script representative of a set of actions to reproduce the selected reported defect 508 (block 804). For example, the defect reproducer 206 may receive a script (e.g., the defect reproduction script 444 of FIG. 4E) that is included in a defect record (e.g., the defect record 432 of FIG. 4E). In some examples, the defect reproducer 206 accesses the defect record 432 and/or the script 444 from a defect manager (e.g., the defect manager 106 of FIG. 1).

An application tester (e.g., the example application tester 204 of FIG. 3) executes the software application to be tested (e.g., the software application under test of FIGS. 5A-5D) (block 806). The example defect reproducer 206 determines whether the software application under test is in a correct state to reproduce the reported defect (block 808). For example, the defect reproducer 206 may identify an initial state (e.g., state A of FIGS. 4B and/or 5B) for performance of a set of actions.

The initial state may be determined from the script 444, a default initial state for the software application under test, specified by a user, and/or any other source of initial state information. For example, the defect reproducer 206 may determine whether the software application under test is in the initial state by comparing the contents of memory allocated to the software application under test to contents of memory for the initial state, determining the states of any enabled add-on applications, determining whether the software application under test is in a programmed steady state (e.g., on the home screen, on a designated menu screen, etc.), and/or otherwise comparing a state of the software application under test with an initial state.

If the software application under test is not in the correct (e.g., initial) state (block 808), the example defect reproducer 206 places the software application under test in the correct (e.g., initial) state (block 810). For example, the defect reproducer 206 may perform one or more interactions with the software application under test via the user interface 202 of FIG. 3. In some other examples, the defect reproducer 206 provides the application tester 204 with data to be placed in the allocated memory of the software application under test 504 to place the software application under test in the initial state.

After placing the software application under test in the initial state (block 810), or if the defect reproducer 206 determines that the software application under test is in the initial state (block 808), the example defect reproducer 206 performs the set of actions (e.g., actions in the script 444) to attempt to reproduce the reported defect (block 812). By performing the set of actions, the example defect reproducer 206 attempts to reproduce the condition via which a user (e.g., a quality assurance engineer) previously determined that the selected defect existed.

A defect verifier (e.g., the defect verifier 314 of FIG. 3) determines whether the reported defect is still present (block 814). For example, the defect verifier 314 may analyze the script 444 to determine whether there are any verification instructions. In some other examples, the defect verifier 314 monitors the user interface 202 for user interactions indicating the presence or absence of the defect (e.g., the user selecting the ‘verify fix’ button 520 or the ‘reject fix’ button 522 of FIGS. 5C and 5D).

If the defect verifier 314 determines that the defect is not present (block 814), the example defect verifier 314 marks the reported defect as fixed (block 816). For example, the defect verifier 816 may change a status or other information in the defect record 432. On the other hand, if the defect is not still present (block 814), the defect verifier 816 returns the reported defect (e.g., to the application developer 102 and/or to the defect manager 106 of FIG. 1) (block 818).

The example instructions 800 may then end. In some examples, the instructions 800 may return control to block 802 to identify the selection of another reported defect for verification.

FIG. 9 is a block diagram of an example processor platform 900 capable of executing the instructions 600, 700, 800 of FIGS. 6-8 to implement the software testers 102, 200, and/or 300 of FIGS. 1-3. The computer 900 can be, for example, a server, a personal computer, or any other type of computing device.

The processor platform 900 of the instant example includes a processor 912. For example, the processor 912 can be implemented by one or more microprocessors or controllers from any desired family or manufacturer. The example processor 912 of FIG. 9 implements the software tester 300 of FIG. 3, including the example application tester 204, the example defect reproducer 206, the example software application under test 208, the example defect verifier 314, the example script recorder 316, and/or the example script generator 318.

The processor 912 includes a local memory 913 (e.g., a cache) and is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller. Any of the example local memory 913, the example volatile memory 914, and/or the example non-volatile memory 916 may store instructions and/or data representative of the software application under test 208, the script 212, and/or the user interaction log 320. The example application tester 204, the example defect reproducer 206, the example software application under test 208, the example defect verifier 314, the example script recorder 316, and/or the example script generator 318 and/or, more generally, the example processor 912 access the software application under test 208, the script 212, and/or the user interaction log 320 from any of the local memory 913, the volatile memory 914, and/or the non-volatile memory 916

The processor platform 900 also includes an interface circuit 920. The interface circuit 920 may be implemented by any type of interface standard, such as an Ethernet interface, a universal serial bus (USB), and/or a PCI express interface.

One or more input devices 922 are connected to the interface circuit 920. The input device(s) 922 permit a user to enter data and commands into the processor 912. The input device(s) can be implemented by, for example, a keyboard, a mouse, a touchscreen, a track-pad, a trackball, isopoint and/or a voice recognition system.

One or more output devices 924 are also connected to the interface circuit 920. The output devices 924 can be implemented, for example, by display devices (e.g., a liquid crystal display, a cathode ray tube display (CRT), a printer and/or speakers). The interface circuit 920, thus, typically includes a graphics driver card. The example interface circuit 920, the example input device(s) 922, and/or the example output device(s) 924 may be used in combination to implement the user interfaces 202 of FIGS. 2 and/or 3.

The interface circuit 920 also includes a communication device such as a modem or network interface card to facilitate exchange of data with external computers via a network 926 (e.g., an Ethernet connection, a digital subscriber line (DSL), a telephone line, coaxial cable, a cellular telephone system, etc.).

The processor platform 900 also includes one or more mass storage devices 928 for storing software and data. Examples of such mass storage devices 928 include floppy disk drives, hard drive disks, compact disk drives and digital versatile disk (DVD) drives. The mass storage device 928 may implement one or more of the application tester 204 (e.g., to store the software application under test 208), the defect reproducer 206 (e.g., to store the script 212), the defect verifier 312 (e.g., to store the script 212), the script recorder 316 (e.g., to store the log 320), and/or the script generator 318 (e.g., to store generated script(s) and/or to store the script 212).

The coded instructions 932 of FIGS. 6-8 may be stored in the mass storage device 928, in the volatile memory 914, in the non-volatile memory 916, and/or on a removable storage medium such as a CD or DVD.

Example methods, apparatus, and articles of manufacture described above provide rapid and efficient verification of software defects. In contrast to known manual methods of software defect verification, example methods, apparatus, and articles of manufacture disclosed herein are more reliable in that they automatically reproduce the steps that resulted in the reporting of a software defect while avoiding the possibility of errors in reproduction that can occur during manual processes. As a result, methods, apparatus, and articles of manufacture permit the development of higher-quality software applications by enabling the allocation of more resources to development and/or testing than would be allocated using previous methods.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method, comprising:
accessing, with a processor, a script representative of a set of actions to be performed when executing a software application to be tested, the set of actions being associated with a reported defect;
executing the software application to be tested on the computer; and
performing, with the processor, the set of actions in the script via the application to be tested to attempt to reproduce the reported defect.

2. A method as defined in claim 1, further comprising:
reporting a defect in the software application to be tested as the reported defect; and
attaching the script to the reported defect.

3. A method as defined in claim 2, further comprising generating the script by recording a plurality of user interactions with the software application.

4. A method as defined in claim 1, further comprising verifying that the reported defect has been removed from the software application when the set of actions in the script has been performed and the defect is not detected.

5. A method as defined in claim 1, further comprising placing the software application to be tested into an initial state prior to performing the set of actions in the script.

6. An apparatus, comprising:
an application tester to execute the software application under test; and
a defect reproducer to attempt to reproduce a reported defect by performing, while the application tester executes the software application under test, a set of actions defined in a script, the set of actions being associated with the reported defect.

7. An apparatus as defined in claim 6, further comprising:
a script recorder to monitor user interactions with the software application under test; and
a script generator to generate the script from the monitored user interactions when the user interface receives an indication that the defect is to be reported.

8. An apparatus as defined in claim 7, wherein the script generator is to generate the script to include user interactions occurring subsequent to the occurrence of a predetermined state of the software application under test.

9. An apparatus as defined in claim 6, further comprising a defect verifier to determine whether the reported defect has been removed from the software application when the set of actions have been performed.

10. An apparatus as defined in claim 6, wherein the defect reproducer is to place the software application under test into an initial state when the software application under test is not in the initial state prior to performing the set of actions.

11. A computer readable storage medium comprising computer readable instructions which, when executed by the computer, cause the computer to a least:
accessing a script representative of a set of actions to be performed when executing a software application to be tested, the set of actions being associated with a reported defect;
execute the software application to be tested on the computer; and
perform the set of actions in the script via the application to be tested to attempt to reproduce the reported defect.

12. A computer readable storage medium as defined in claim 11, wherein the instructions are further to cause the computer to:
report a defect in the software application to be tested as the reported defect; and
attach the script to the reported defect.

13. A computer readable storage medium as defined in claim 11, wherein the instructions are further to cause the computer to generate the script by recording a plurality of user interactions with the software application.

14. A computer readable storage medium as defined in claim 11, wherein the instructions are further to cause the computer to verify that the reported defect has been removed from the software application when the set of actions in the script has been performed and the defect is not detected.

15. A computer readable storage medium as defined in claim 11, wherein the instructions are further to cause the computer to place the software application to be tested into an initial state prior to performing the set of actions in the script.
